(19) United States
(12) Patent Application Publication
(10) Pub. No.: US 2026/0350692 A1
(43) Pub. Date: Nov. 5, 2026

(54) SYSTEMS AND TECHNIQUES TO PERFORM TAP-TO-FUNCTIONS WITH CONTACTLESS CARDS IN A PROPERTY MANAGEMENT ENVIRONMENT

(71) Applicant: Capital One Services, LLC, McLean, VA (US)

(72) Inventors: Anita Eradla, McLean, VA (US); Tribhuvan Kambham, McLean, VA (US); Kimberly Haynes, McLean, VA (US); Jennifer Valenti, McLean, VA (US); Kevin Widener, McLean, VA (US)

(73) Assignee: Capital One Services, LLC, McLean, VA (US)

(21) Appl. No.: 19/196,032

(22) Filed: May 1, 2025

(51) Int. Cl. G06Q 30/0645; G06Q 30/01; G06Q 30/04; G06Q 30/06; G06Q 50/163

(52) U.S. Cl. CPC G06Q 30/0645; G06Q 30/04; G06Q 30/06; G06Q 50/163; G06Q 30/01

(57) ABSTRACT

Embodiments are directed to providing systems, devices, and method to perform onboarding services in a property management platform with contactless cards and banking systems.

### BACKGROUND

Property management platforms provide a number of services for property managers, owners, and tenants of rental properties. These services may include providing occupancy and availability information, property-specific information (e.g., number of bedrooms, bathrooms, etc.), tenant/manager communication services, etc. In some instances, these platforms may enable new tenants and property managers/owners to perform onboarding services, such as reviewing and signing lease agreements, establishing rental payment plans, and other onboarding services (e.g., connecting utilities). However, these operations are typically cumbersome. For example, a new tenant may have to review and sign a lease agreement, sometimes requiring the tenant to print out the agreement, physically sign the agreement, and scan the signed agreement back into the computer system to provide to the property management system. Additionally, to establish a payment plan, a new tenant may have to manually enter their banking information, including their routing number and bank account, and fill out physical paperwork. Embodiments discussed herein simplify and improve these operations and services provided by property management and banking systems by utilizing technological advancements in contactless cards, property management platforms, and banking systems.

### BRIEF SUMMARY

Embodiments may generally be directed to methods and systems to perform operations with contactless cards. For example, embodiments may include a computing system having memory configured to store instructions, and one or more processors coupled with the memory, the one or more processors can be configured to execute the instructions. The instructions, when executed, cause one or more processors to receive and process data from a property management platform, the data may include a property identifier to identify a property and a customer identifier to identify a customer. One or more processors may also receive and process an indication from a computing device to configure a payment schedule for the property with an account associated with the customer. The system may receive, via the computing device, a cryptogram from a contactless card, verify, with the cryptogram, that the contactless card is associated with the customer, and establish the payment schedule for the property with the account based on verifying the contactless card is associated with the customer.

In another example, embodiments may include systems and methods including receiving, by a banking system, a request to establish a payment schedule for a property utilizing an account associated with a customer from a property management platform, the request comprising a property identifier to identify the property and a customer identifier to identify the customer, sending, to a mobile device associated with the customer, a second request to perform a verification with a contactless card, receiving, via the mobile device, a cryptogram from the contactless card, verifying, by the banking system, the cryptogram, and establishing the payment schedule for the property with the account based on the verifying of the cryptogram.

In a third example, embodiments may include methods and devices, such as mobile device, including a display device, a memory configured to store instructions for a banking application, and a processor coupled with the memory and the display device, and configured to execute the instructions. The processor, when executing the instructions, may receive and process, from a banking system, a request to provide data stored on a contactless card as part of an onboarding process to establish a payment schedule to provide payment to a property management platform, present, on the display device, prompt comprising instructions to tap or bring the contactless card within a wireless communication range of the mobile device, receive a cryptogram from the contactless card based on the contactless card coming within the wireless communication range, and send the cryptogram to the banking system for verification to establish the payment schedule.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system 100 in accordance with embodiments discussed herein.

FIG. 2 illustrates an example of a sequence flow 200 in accordance with some embodiments discussed herein.

FIG. 3 illustrates a routine 300 in accordance with some embodiments discussed herein.

FIG. 4 illustrates a routine 400 in accordance with some embodiments discussed herein.

FIG. 5 illustrates a routine 500 in accordance with some embodiments discussed herein.

FIG. 6 illustrates an example of a system 600 in accordance with the embodiments discussed herein.

FIG. 7 illustrates an example of a system 700 in accordance with some embodiments.

FIG. 8 illustrates a contactless card 102 in accordance with some embodiments.

FIG. 9 illustrates a transaction card component 900 in accordance with some embodiments.

FIG. 10 illustrates a sequence flow 1000 in accordance with embodiments.

FIG. 11 illustrates a data structure 1100 in accordance with embodiments.

FIG. 12 is a diagram of a key system according to an example embodiment.

FIG. 13 is a flowchart of a method of generating a cryptogram according to an example embodiment.

FIG. 14 illustrates an example of a routine 1400 in accordance with embodiments.

FIG. 15 illustrates an example of a routine 1500 in accordance with embodiments.

FIG. 16 illustrates a computer architecture 1600 in accordance with one embodiment.

FIG. 17 illustrates a communications architecture 1700 in accordance with one embodiment.

### DETAILED DESCRIPTION

Embodiments discussed herein are generally directed to a banking system configured to provide services and features to third-party platforms. For example, a system discussed herein is configured to operate with property management platforms to enable the property management platforms to extend their services to the customers of the banking system to provide more straightforward and more efficient onboarding and payment processes.

In one example, the banking system provides verification services for the property management platforms to verify new customers, enable new customers to establish automatic electronic payments, and perform additional onboarding processes, including signing lease agreements. The banking system seamlessly provides these services to customers with fewer operations than previous solutions. These solutions discussed herein are made possible by technical improvements implemented by the banking system utilizing computer services and application programming interfaces to integrate processes performed with the property management platforms with the banking system. Technical improvements have been made to the banking system and contactless cards, such that a contactless card may be used to perform a number of operations in addition to traditional transactional services, such as single tap authentication and other tap-to-perform functions implemented in contactless cards and banking systems.

Previous solutions include third-party property management platforms that operate independently from the banking system requiring customers to go through a number of extra steps to lease a property through an online environment provided by the property management platform. For example, in addition to all the steps that a customer is required to perform to sign up with the property management platform to lease the property, including reviewing and confirming the lease agreement, a customer would be required to through their banking system to establish a payment schedule between the banking system and platform to provide payment for the lease.

Embodiments discussed herein simplify these previous solutions by integrating the onboarding process between the property management platform, the banking system, and the customer. The customer may perform a number of actions, including establishing a payment schedule and signing a lease agreement via a mobile device with their contactless card. For example, the banking system is configured to perform verification processes to verify a customer based on information stored on a contactless card. Thus, as part of the onboarding process, a customer may be requested to verify themselves by tapping their contactless card on their mobile device. The contactless card may be configured to generate a cryptogram and send the cryptogram to the banking system via the mobile device. The banking system may verify the customer for the property management system.

The customer may also establish a payment schedule with an account associated with the customer. For example, based on the tap to verify operation performed above, or one or more additional tap operations, the banking system may establish and set up a payment plan with a property management platform including providing banking information to enable the property management platform to receive payment from a particular customer. These and other details will become more apparent in the following description.

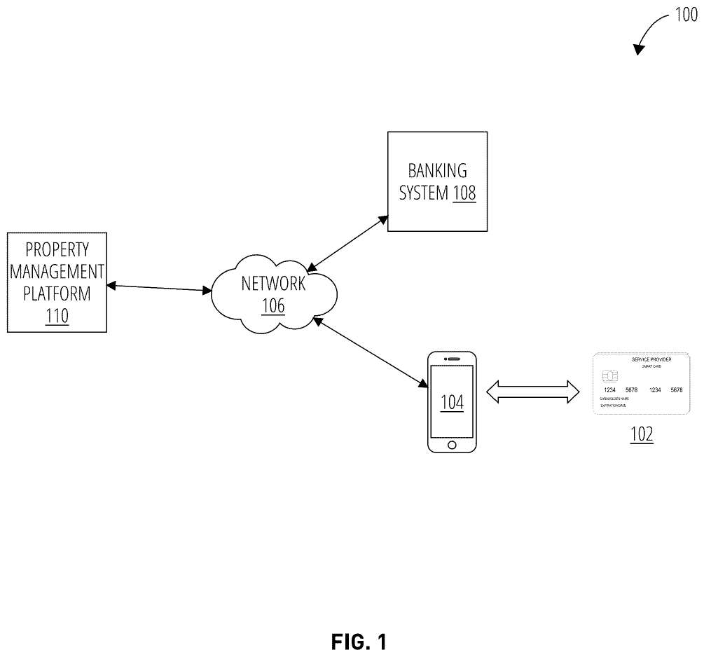

FIG. 1 illustrates an example of a system 100 in accordance with embodiments. The illustrated system 100 includes other systems, platforms, devices, etc., that may be utilized to perform the operations discussed herein. Note that system 100 is illustrated in a simplistic view for discussion purposes. In an implementation, system 100 includes many additional systems, devices, components, etc., to perform computing system operations, and embodiments are not limited in this manner.

System 100 may be one example configuration to perform contactless card operations and interact with a property management platform. For example, system 100 may enable customers to rent a property, perform an onboarding process, perform verification operations, establish payment, etc., and additional operations with the contactless card 102. System 100 may include a banking system 108, a property management platform 110, and a computing device 104, such as a customer's mobile phone, coupled via one or more networks 106.

System 100 includes a property management platform 110 that customers, property managers, and owners may utilize to perform operations associated with renting or leasing a property. The property management platform 110 may include a number of computing devices, such as servers, networking devices, computers, etc., to enable one or more customers and operators to perform the operations associated with property management. The operations may include enabling customers to select units to rent, virtually viewing properties, and performing onboarding processes. The onboarding processes may include finalizing a property to rent, reviewing/signing a lease agreement, and establishing a payment schedule for the property. Additional operations provided by the property management platform 110 may include management operations, hosting important documents, e.g., bylaws, covenants providing repair requests, providing a system request for an update or upgrade for a property, etc.

The property management platform 110 is a software system designed to help property managers streamline their operations and manage their properties more efficiently. The platform 110 is typically used by property managers, landlords, real estate investors to manage rental properties, collect rent payments, handle maintenance requests, and keep track of financial records. In embodiments, the property management platform 110 may be configured in a number of ways, depending on the specific needs of the property manager or landlord. The property management platform 110 may include features such as a property management feature that allows property managers to manage their properties, including leasing, maintenance, and financial management, a tenant management feature that allows property managers to manage their tenants, including tenant screening, lease management, and rent collection, and a maintenance management feature that allows property managers to manage maintenance requests and repairs, as well as schedule preventive maintenance tasks. Additional features may include a financial management feature that allows property managers to manage the financial aspects of their properties, including rent collection, accounting, and reporting, and a communication feature that allows property managers to communicate with tenants, vendors, and other stakeholders through various channels, such as email, text messaging, and in-app messaging, and an analytics and reporting feature that allows property managers to track performance metrics, analyze trends, and generate reports to help them make data-driven decisions.

In some embodiments, the property management platform 110 can run on a variety of hardware configurations depending on the specific software and the requirements of the user. In some instances, the property management platform 110 is cloud-based, that is hosted on remote servers, and accessed through an Internet connection. Cloud-based platforms can be accessed from any device with an Internet connection, including desktop computers, laptops, tablets, and smartphones. The platform 110 is compatible with web browsers, such as Google Chrome, Mozilla Firefox, and Microsoft Edge. In some instances, the property management software may be local and operate as a desktop application on one or more computers. Embodiments are not limited in this manner.

In embodiments, the system 100 also includes a banking system 108 to enable customers to perform typical banking operations. The banking system 108 may be configured to provide a number of services to customers through a web-based interface, and a mobile application that operates on a device, such as a computing device 104. Traditional services include enabling customers to access accounts, view account balances, view charges, update account settings, and profile information, dispute charges, send money, configure payments, and so forth.

In embodiments, the banking system 108 is made up of both hardware and software components, which work together to provide the necessary infrastructure to manage banking transactions and operations. For example, the banking system 108 may include servers or a network of servers that host the various software applications and databases that support banking operations, storage devices, such as hard drives and solid state drives, to store data and application files, and network infrastructure including routers, switches, and firewalls, to facilitate communication between different parts of the system and ensure security.

In embodiments, the banking system 108 may execute software, such as core banking software that manages all banking transactions and operations, including account management, transaction processing, and security management. The banking system 108 may also include customer relationship management (CRM) software that tracks customer interactions and provides tools for managing customer relationships, that handles the processing of electronic payments, including credit and debit card transactions, online payments, and wire transfers, risk management software that monitors and manages the various types of risks associated with banking operations, including credit risk, market risk, and operational risk, and compliance and regulatory software to help the bank stay in compliance with regulatory requirements and manage regulatory reporting.

The banking system 108 may also be configured to operate with property management platforms 110, to provide third-party business services, as discussed herein. For example, in embodiments discussed herein, the banking system 108 may provide verification and payment services for the property management platform 110. The property management platform 110 may utilize the services to verify customers and automatically configure payment schedules and sign lease agreements.

In embodiments, the banking system 108 may be configured with a number of services and application programming interfaces (APIs) that the property management platforms 110 may utilize to perform the additional services with the banking system 108. In the illustrated example, the banking system 108 may be configured with one or more services and APIs to handle and process requests to verify customers. The verification process may be utilized by the property management platform 110, for example, as part of a lease agreement signing and to generate a payment schedule. The banking system 108 may receive the request and perform the verification based on the information in the request utilizing a customer's computing device and the contactless card 102, for example.

In embodiments, the computing device 104 may be a device such as a mobile phone, a mobile device, a personal digital assistant, a wearable device, a personal computer, etc., The computing device 104 may include a number of components, including processor(s), memory, storage, interfaces, displays, input/output (I/O) devices, battery, buttons, etc., to perform the operations discussed herein. The components may be coupled with each other via one or more interconnects and configured to operate together. Moreover, the computing device 104 is configured to operate with other devices via wired and wireless interfaces. In embodiments, the computing device 104 is not limited in this manner and may include additional components and circuitry.

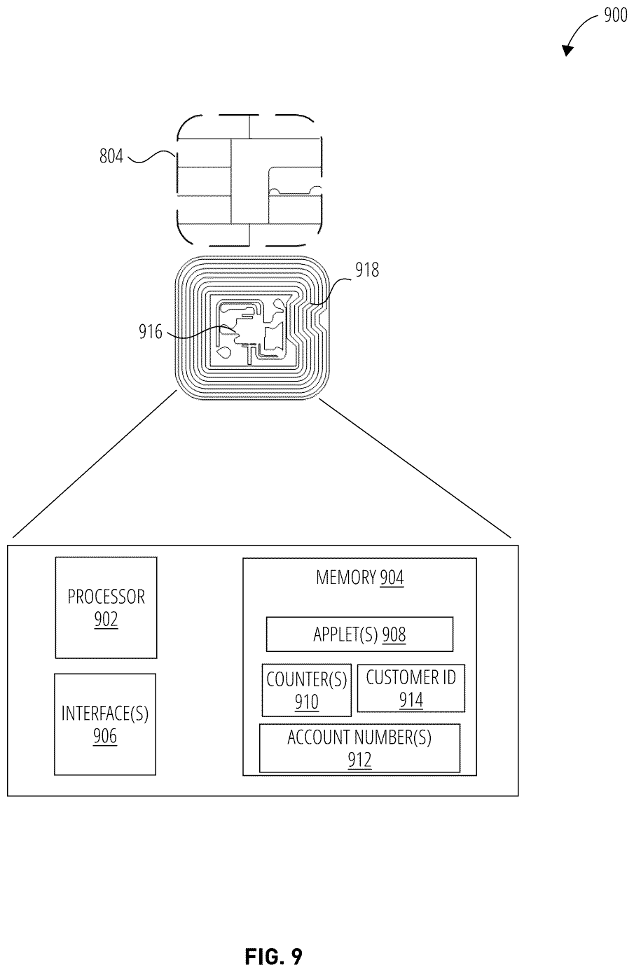

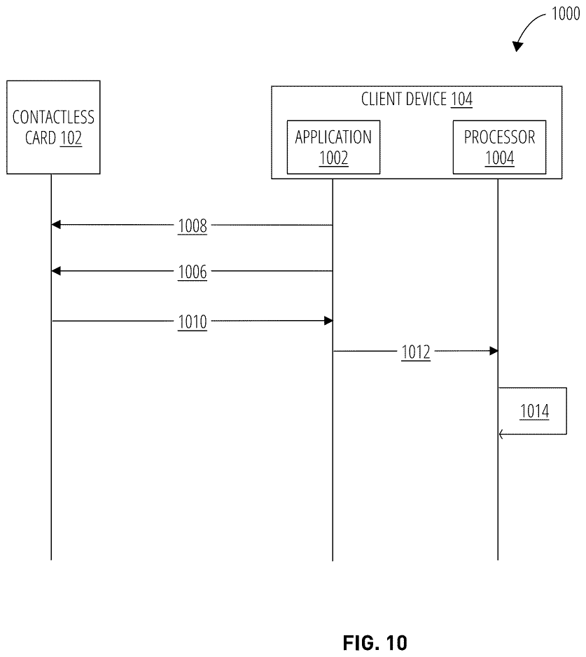

In embodiments, the contactless card 102 may be any type of contactless card, as discussed herein in FIG. 9 and FIG. 10, such as a credit card, a banking card, an identification card, etc. In embodiments, the contactless card 102 may be associated with the banking system 108, e.g., the issuing bank of the contactless card 102 also operates the banking system 108. The computing device 104 and the contactless card 102 may be associated with the customer in the banking system 108. For example, a phone number for the computing device 104 may be stored as a record on the banking system 108. In addition, the computing device 104 may be configured to execute software provided by the banking system 108, e.g., a banking app. The user may be required to log into an account while operating the banking app to provide additional security. In some instances, the customer may access banking app features on the computing device 104 through a web portal presented in a web browser. Similarly, the customer may be required to go through a login process when accessing the web portal. As will be discussed in more detail, the banking system 108 may utilize the customer's computing device 104 to perform the verification operations with the contactless card 102. Moreover, the following description includes a number of sequences and routines performed by the various devices illustrated in system 100 to provide customers with onboarding services to rent a property.

In embodiments, the system 100 enables new customers or new tenants to rent a property, sign a lease agreement, and establish a payment plan between their banking system and the property management platform. In one example, the customer may utilize a computing device 104, such as their mobile phone to perform these operations. For example, the customer may access a website via a web browser or execute an application on the device 104 to review and perform the operations. As part of the onboarding process, the customer may be presented with options to sign a lease and/or establish a payment plan with the bank in a graphical user interface (GUI) presented on the display of the computing device 104.

In one example, once a customer has selected a property to rent or lease, the computing device 104 may present an option for the customer to review and sign the rental or lease agreement. Traditionally, the customer may be required to print out the agreement, review and physically sign the agreement, and return the signed agreement by either mail or scanning it back into a computer system. Some systems may enable a customer to “electronically sign” the document with a computerized signature by having the customer enter their initials. However, these systems may be unsecured and a person other than the tenant may sign the agreement. Embodiments discussed herein provide advantages over these systems by utilizing the authentication techniques described herein to authenticate or verify the user with their contactless card 102.

For example, the contactless card 102 can include a unique identifier associated with the customer, that may be provided to the computing device 104 and verified by the banking system 108 ensuring that the card 102 is associated with the customer. In some instances, the contactless card 102 may be utilized as one factor in a multi-factor verification process. The contactless card 102 may be verified and the customer may be required to provide additional information, e.g., sign in to an application, respond to a text message, provide a code, etc. In either case, verification utilizing the contactless card 102 may be utilized to sign the lease agreement.

In a specific example, the customer may be presented with the lease or rental agreement to review on a display of the computing device 104. At the end of the agreement, the customer may be requested to tap their contactless card 102 on the computing device 104 (i.e., bring the card 102 within wireless communication range) to accept and sign the lease or rental agreement. As will be discussed in more detail below, tapping the card 102 on the device 104 initiates an exchange of information between the card 102, the device 104, and the banking system 108 to verify the customer and contactless card 108. The banking system 108 may provide an indication as to whether the customer is verified or not to the property management platform 110.

Additionally, the customer may utilize the contactless card 102 and their computing device 104. Similarly, the customer may be presented with options to establish a payment plan in a GUI on the computing device 104. The options may include selecting a date to pay rent. The customer may be requested to tap the contactless card 102 to the computing device 104 to establish the payment plan between the banking system 108 and the property management platform 110. These and other details are discussed below in regard to the following flows and diagrams.

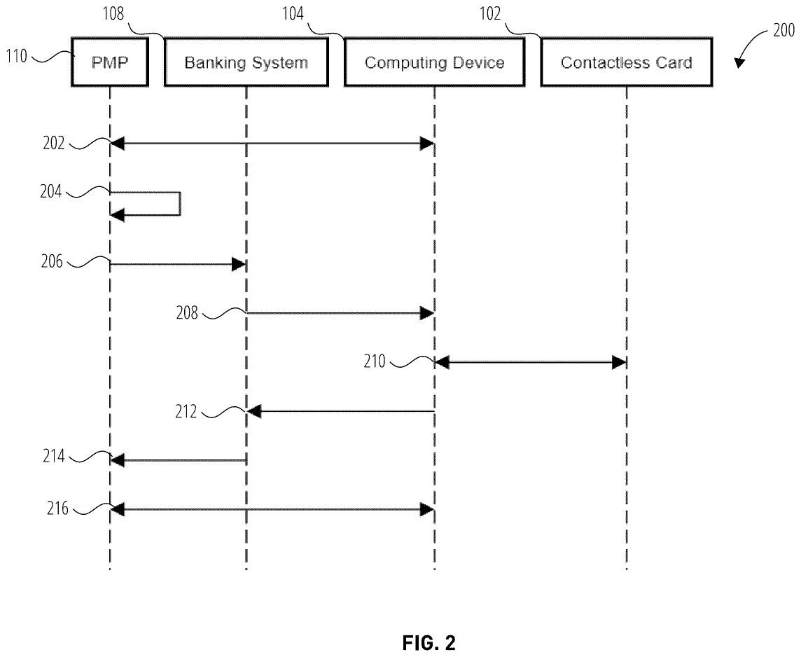

FIG. 2 illustrates an example of a sequence flow 200 in accordance with the embodiments discussed herein. The sequence flow 200 illustrates one possible sequence to perform the operations to onboard a tenant on the property management platform 110 including verifying the customer and creating connections with the banking system 108.

At 202, the property management platform 110 may establish an onboarding process with at least one of the computing devices 104 and the banking system 108 for a customer to establish a lease for a property. The onboarding process may include a number of operations for the customer to perform with the property management platform 110, including signing an electronic lease agreement and establishing a payment schedule to electronically pay for the property periodically, e.g., monthly.

In the illustrated example, the property management platform 110 may communicate with the customer via their computing device 104 through a mobile application or website presented in a web browser. The computing device 104 may present one or more displays corresponding to the onboarding process in a click-through manner. For example, the customer may be presented with displays to browse properties, select a property, review their selection, review and approve the lease terms and sign the electronic lease agreement, and establish a payment schedule by configuring a payment account to pay the property management platform 110, for example.

In embodiments, the property management platform 110 may be configured to verify the customer to enable them electronically sign the lease agreement and/or establish the electronic payment with the customer's account. In embodiments, the property management platform 110 may verify the customer with the banking system 108 via the customer's banking or contactless card, e.g., the card represents a token the customer has in their possession. And as described herein, the contactless card 102 includes a unique identifier associated with the customer that the banking system 108 can verify based on a comparison.

At 204, the property management platform 110 may process the data from computing device 104 to allocate the property for rent, including reserving the property. In addition, at 206, the property management platform 110 may determine to verify the customer via the contactless card 102 and communicate with the banking system 108. The communication may include a request to verify the customer for the lease agreement and/or establish a payment schedule for the customer to pay rent. In embodiments, the banking system 108 may provide one or more application programming interface(s) other systems, such as the property management platform 110, can use to request certain services and data, e.g., perform a verification of a customer, establish a payment schedule, etc. Thus, the banking system 108 may receive the request via an API communication; however, embodiments are not limited in this manner.

In embodiments, the request may include a property identifier to identify the property and a customer identifier to identify the customer. A property identifier may include an address, a building name/apartment number, a unit number, or some other identifier that can be used to uniquely identify the property. In some instances, the banking system 108 may utilize the property identifier when sending payment each month to the property management platform 110 on the periodic basis to identify the property. In embodiments, the customer identifier may be a name, a phone number, a social security number, or something identifier that can be used to identify the customer. The banking system 108 may utilize the customer identifier to perform the verification of the customer.

In the illustrated embodiment, at 208, the banking system 108 may communicate with the computing device 104 to perform the verification process with the customer. In one example, the banking system 108 may send a message or communication to a banking app on the computing device 104. The message may include a request for data from the contactless card 102. In some instances, the message may cause the banking app to display a message on a display of the computing device 104 to prompt the customer to provide or tap the contactless card 102 on a surface of the computing device 104, e.g., “TAP CONTACTLESS CARD HERE.” In some instances, the message may be communicated to the computing device 104 via a web communication to a web browser presenting a banking website to the customer on the display. In embodiments, the customer may be required to enter login information to access the banking app or a particular webpage.

In some instances, the computing device 104 may display additional information to the customer. For example, the computing device 104 may present information indicating that the customer is being verified as a part of an onboarding process to lease a property and configure a payment schedule. In some instances, the verifying process may be utilized to ‘sign’ the lease agreement. For example, the customer may be presented with the lease agreement and requested to tap the card on the device once the customer agrees to the terms of the lease. Similarly, the customer may also be presented with information to schedule a payment schedule and then asked to tap the card on the device.

At 210, the computing device 104 and the contactless card 102 may exchange information, e.g., as a result of the card coming within the communication range of the device. The exchange may be part of a near-field communication (NFC) exchange, and the communication range may be ~10 centimeters, i.e., the range of NFC communication. In embodiments, the computing device 104 may receive a cryptogram from the contactless card 102 as part of the exchange. The cryptogram may be encrypted by the contactless card 102, as discussed herein, and include data to verify the card/customer. For example, the cryptogram may include at least a unique identifier securely stored on the contactless card 102 and a counter value that increments every read function processed by the contactless card 102. The cryptogram can include additional information, and embodiments are not limited in this manner.

At 212, the computing device 104 communicates with the banking system 108. For example, the computing device 104 may send the cryptogram to the banking system 108 to verify the customer. As discussed, the cryptogram may be encrypted by the contactless card 102, and the computing device 104 may act like a pass-through device for the contactless card 102 to send the cryptogram to the banking system 108.

The banking system 108 may receive the cryptogram and perform one or more verification operations. For example, the verification process may include generating keys from data associated with the customer. The keys may be used to decrypt the cryptogram. If the keys cannot successfully decrypt the cryptogram, the verification process may fail. If the banking system 108 successfully decrypts the cryptogram, the banking system 108 may further verify the data in the cryptogam, i.e., the unique identifier and/or the counter value. For example, the banking system 108 may ensure the unique identifier matches a verified unique identifier for the customer and that the counter value matches or is within an acceptable range of a stored counter value maintained for the card. If any part of the verification process fails, the banking system 108 may halt the onboarding process and set up the payment schedule. However, if the verification process is successful, the banking system 108 may communicate with the property management platform 110 and configure a payment schedule to pay for the property.

At 214, the banking system 108 may communicate to the property management platform 110. For example, the banking system 108 may send an indication of the result of the verification process, e.g., whether verification was successful or not. If successful, the banking system 108 may exchange information with the property management platform 110 to configure a payment schedule, e.g., the banking system 108 may provide payment to the property management platform 110 from an account associated with the contactless card 102 on a monthly basis. The information exchanged between the banking system 108 and the property management platform 110 may include an account identifier, a customer identifier, a property identifier, etc. Additional information may be a payment date of the month, etc.

In embodiments, the banking system 108 may send an indication the customer accepted or agreed to the lease terms to the property management platform 110. As mentioned, the customer may sign the lease agreement by tapping their card and causing an exchange of information when presented with the lease agreement. The property management platform 110 may store an electronic token or signature indicating the customer signed the agreement.

At 216, the property management platform 110 may communicate with the computing device 104. For example, the property management platform 110 may indicate whether the onboarding process, payment schedule, and lease signing are successfully completed. In one example, the property management platform 110 may send data to the customer to be presented in an app or on a webpage. The app or webpage may enable to control of one or more settings and information corresponding to the customer's lease agreement with the property management platform.

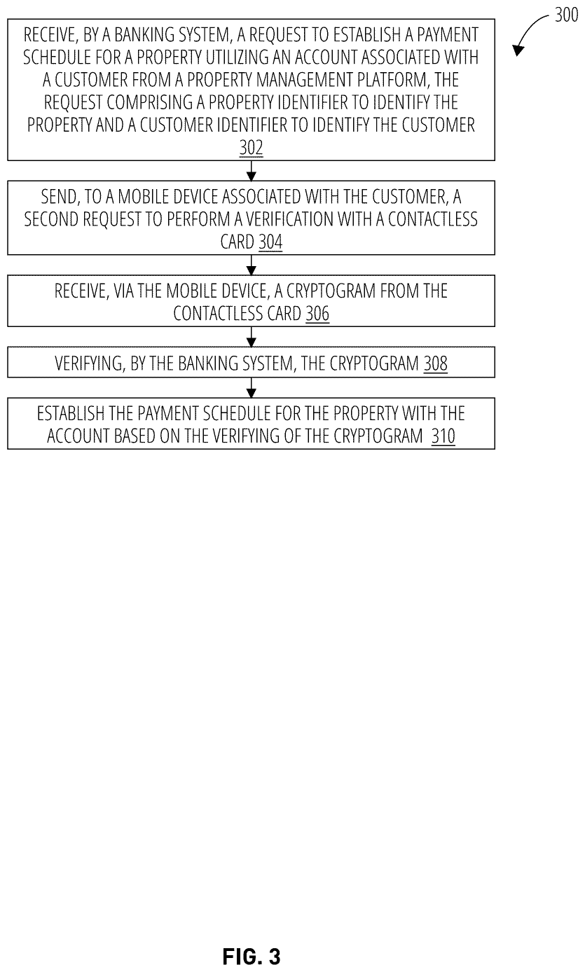

FIG. 3 illustrates an example of a routine 300 that may be performed by a banking system in accordance with embodiments. Specifically, the routine 300 includes one or more steps a banking system may perform to provide verification functions and establish a payment schedule with an online property management platform.

In block 302, the routine 300 includes receiving, by a banking system, a request to establish a payment schedule for a property. For example, the request may be received from a server of a property management platform as part of an onboarding process. Note that in some instances, the request may be received from a computing device, such as a customer's mobile phone, as part of the onboarding process, and embodiments are not limited in this manner. The request may include an indication that a customer and the property management platform is setting up a payment schedule utilizing an account associated with a customer. The request may include a property identifier to identify the property and a customer identifier to identify the customer.

In block 304, routine 300 includes sending, by the banking system, a request to perform a verification with a contactless card to a computing device associated with the customer. For example, the banking system may send a request to an app executing on a mobile device, send the request to a web browser on the mobile device, send a text message, etc. The request may cause a prompt to present on the mobile device's display instructing the customer to tap their contactless card onto the device to initiate an exchange. In embodiments, the mobile device and the contactless card may perform a wireless communication exchange, and the mobile device may receive a cryptogram from the contactless card. The mobile device may forward the cryptogram, and the banking system may receive the cryptogram at block 306. In embodiments, the cryptogram includes information, such as a unique identifier and a counter value to be verified.

In block 308, routine 300 includes verifying the cryptogram by the banking system. Specifically, the banking system decrypts the cryptogram to extract the identifier and the counter value. As a first check, if the banking system fails to decrypt the cryptogram, verification fails. Once the banking system extracts the data from the cryptogram, the banking system determines stored values for the contactless card to verify the received values. The banking system may verify the received values against the stored values. Specifically, the banking system ensures that the unique identifier matches the stored unique identifier, and the counter value matches the stored value counter. As discussed herein, the counter values may get out of synchronization for any number of reasons, e.g., accidental read. Thus, in some instances, a range of values may be acceptable, e.g., within five reads. If the banking system fails to verify the customer and/or the card, the banking system will cease any additional operations and send an indication to the property management platform and the customer. If the banking system verifies the customer and contactless card, the banking system proceeds with performing additional operations, such as establishing a payment schedule.

In block 310, routine 300 includes establishing the payment schedule for the property. For example, the banking system may send one or more communications to the property management platform to establish a periodic payment schedule, e.g., on a monthly basis, using money from an account associated with the contactless card. Each month, the banking system may automatically provide payment in a secure electronic manner.

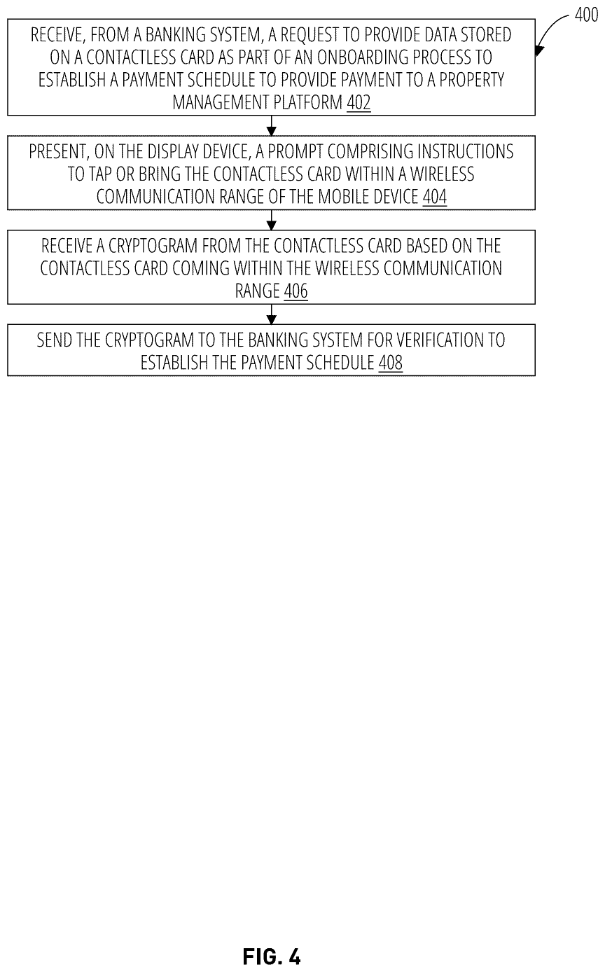

FIG. 4 illustrates an example routine 400 that may be performed by a computing device, such as a mobile device or mobile phone of a customer, in accordance with embodiments. In the illustrated routine 400 the computing device may perform operations to establish payment for a property utilizing a contactless card for verification.

In block 402, routine 400 includes receiving, from a banking system, a request to provide data stored on a contactless card as part of an onboarding process to establish a payment schedule to provide payment to a property management platform. The data may be used to verify the customer and confirm that the customer agrees to the payment. In embodiments, the request may be received via an app on the computing device, through a webpage presented in a web browser, a text message, etc.

In block 404, routine 400 includes presenting, on the display device, a prompt comprising instructions to tap or bring the contactless card within a wireless communication range of the mobile device. For example, the instructions may instruct the customer to tap the card on the display of the computing device, ensuring that the card is close enough to perform NFC communications. Bringing the card within communication distance of the computing device may provide power to the contactless card and initiate an exchange of data between the card and the computing device.

In block 406, routine 400 includes receiving a cryptogram from the contactless card based on the contactless card coming within the wireless communication range. The cryptogram may be encrypted and include an identifier and a counter value, as discussed herein. Further and at block 408, routine 400 includes sending the cryptogram to the banking system for verification to establish the payment schedule. The computing device may send the cryptogram in a message via an API or through another network communication.

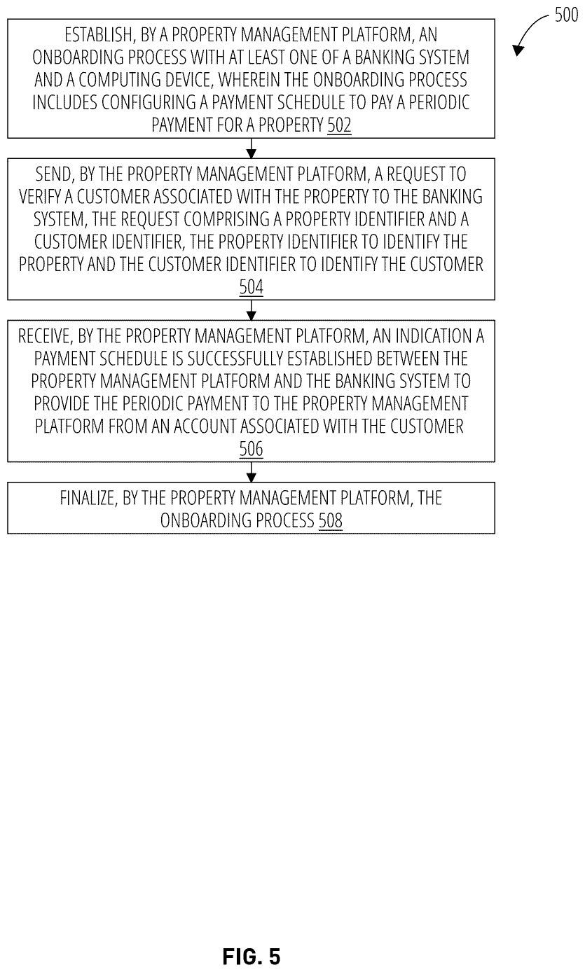

FIG. 5 illustrates an example routine 500 that a property management platform may perform in accordance with embodiments. For example, the property management platform may perform one or more following operations as part of an onboarding process to establish a payment schedule with a new customer.

In block 502, routine 500 includes establishing, by a property management platform, an onboarding process with at least one of a banking system and a computing device. For example, the property management platform may communicate with a banking system and a computing device associated with a customer renting a property managed by the platform. The onboarding process may include a number of operations including configuring a payment schedule to pay a periodic payment for a property. Configuring the payment schedule may include verifying the customer and establishing a payment link between the customer's bank and the platform for the bank to pay periodically.

In block 504, routine 500 includes sending, by the property management platform, a request to verify a customer associated with the property to the banking system. In embodiments, the request may include a property identifier and a customer identifier, the property identifier identifies the property, and the customer identifier identifies the customer.

In block 506, routine 500 includes receiving, by the property management platform, an indication that a payment schedule is successfully established between the property management platform and the banking system to provide the periodic payment to the property management platform from an account associated with the customer. In some instances, the property management platform may receive information from the banking system to establish the periodic payment with an account associated with the customer. The information may include banking information, e.g., a bank account identifier, a bank identifier (routing number), customer information (name, address, phone number), due date, etc. This information may be utilized by the property management platform to perform each periodic payment.

At block 508, routine 500 includes finalizing, by the property management platform, the onboarding process. For example, the property management platform may communicate with the customer's computing device an indication that the onboarding process is complete.

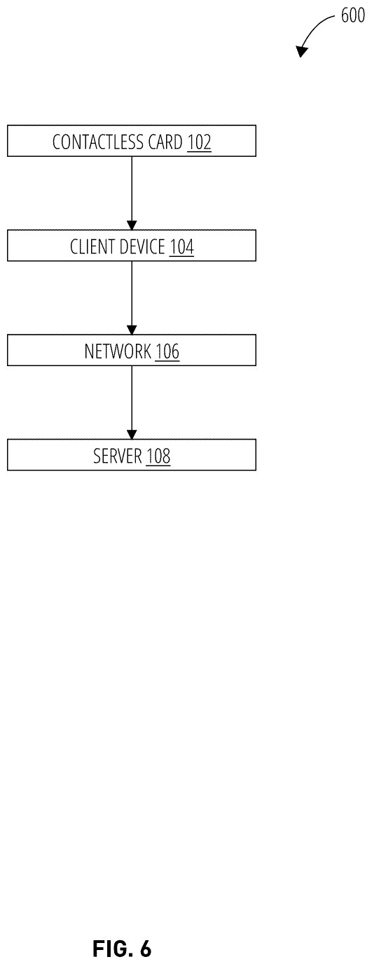

FIG. 6 illustrates a data transmission system 600 according to an example embodiment. As further discussed below, system 600 may include contactless card 102, computing device 104, network 106, and banking system 108. Although FIG. 6 illustrates single instances of the components, system 600 may include any number of components.

System 600 may include one or more contactless cards 102, which are further explained below. In some embodiments, contactless card 102 may be in wireless communication, utilizing NFC for example, with computing device 104.

System 600 may include computing device 104, which may be a network-enabled computer. As referred to herein, a network-enabled computer may include but is not limited to a computer device, or communications device including, e.g., a server, a network appliance, a personal computer, a workstation, a phone, a handheld PC, a personal digital assistant, a thin client, a fat client, an Internet browser, or other device, computing device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The computing device 104 device can include a processor and a memory, and it is understood that the processing circuitry may contain additional components, including processors, memories, error and parity/CRC checkers, data encoders, anticollision algorithms, controllers, command decoders, security primitives and tamper-proofing hardware, as necessary to perform the functions described herein. The computing device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, computing device 104 of system 600 may execute one or more applications, such as software applications, that enable, for example, network communications with one or more components of system 600 and transmit and/or receive data.

The computing device 104 may be in communication with one or more server(s) 108 via one or more network(s) 106, and may operate as a respective front-end to back-end pair with banking system 108. The computing device 104 may transmit, for example from a mobile device application executing on computing device 104, one or more requests to banking system 108. The one or more requests may be associated with retrieving data from banking system 108. The banking system 108 may receive the one or more requests from computing device 104. Based on the one or more requests from computing device 104, banking system 108 may be configured to retrieve the requested data from one or more databases (not shown). Based on receipt of the requested data from the one or more databases, banking system 108 may be configured to transmit the received data to computing device 104, the received data being responsive to one or more requests.

System 600 may include one or more networks 106. In some examples, network 106 may be one or more of a wireless network, a wired network or any combination of wireless network and wired network, and may be configured to connect computing device 104 to banking system 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 1302.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 600 may include one or more systems 108. In some examples, banking system 108 may include one or more processors, which are coupled to memory. The banking system 108 may be configured as a central system, server or platform to control and call various data at different times to execute a plurality of workflow actions. Server 120 may be configured to connect to the one or more databases. The banking system 108 may be connected to at least one computing device 104.

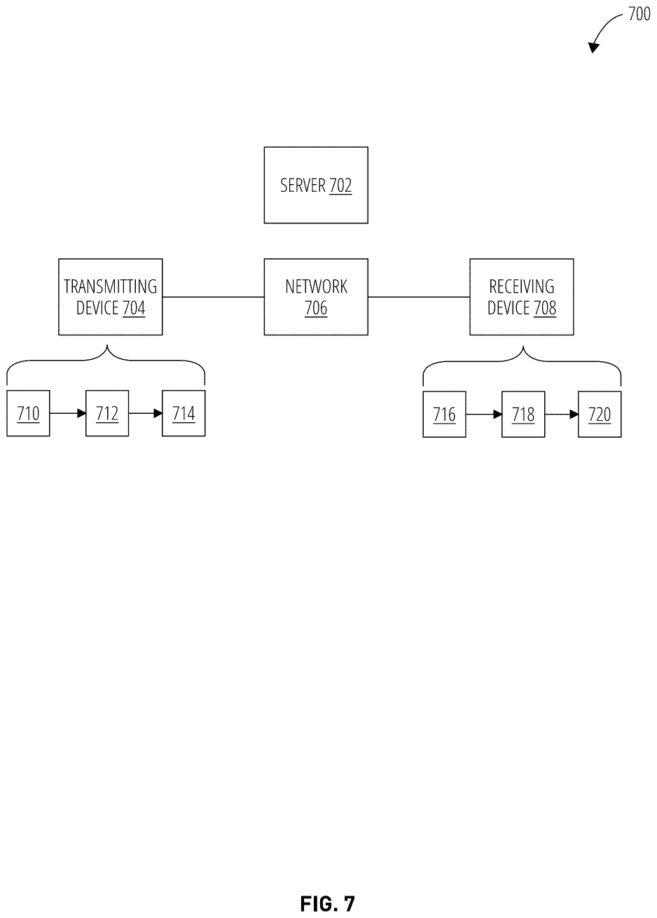

FIG. 7 illustrates a data transmission system according to an example embodiment. System 700 may include a transmitting or transmitting device 704, a receiving or receiving device 708 in communication, for example via network 706, with one or more servers 702. Transmitting or transmitting device 704 may be the same as, or similar to, computing device 104 discussed above with reference to FIG. 1. Receiving or receiving device 708 may be the same as, or similar to, banking system 108 discussed above with reference to FIG. 1. Network 706 may be similar to network 106 discussed above with reference to FIG. 1. Although FIG. 7 shows single instances of components of system 700, system 700 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 7, system 700 may be configured to implement key diversification. For example, a sender and recipient may desire to exchange data (e.g., original sensitive data) via respective devices 704 and 708. As explained above, although single instances of transmitting device 704 and receiving device 708 may be included, it is understood that one or more transmitting devices 704 and one or more receiving devices 708 may be involved so long as each party shares the same shared secret symmetric key. In some examples, the transmitting device 704 and receiving device 708 may be provisioned with the same master symmetric key. Further, it is understood that any party or device holding the same secret symmetric key may perform the functions of the transmitting device 704 and similarly any party holding the same secret symmetric key may perform the functions of the receiving device 708. In some examples, the symmetric key may comprise the shared secret symmetric key which is kept secret from all parties other than the transmitting device 704 and the receiving device 708 involved in exchanging the secure data. It is further understood that both the transmitting device 704 and receiving device 708 may be provided with the same master symmetric key, and further that part of the data exchanged between the transmitting device 704 and receiving device 708 comprises at least a portion of data which may be referred to as the counter value. The counter value may comprise a number that changes each time data is exchanged between the transmitting device 704 and the receiving device 708.

System 700 may include one or more networks 706. In some examples, network 706 may be one or more of a wireless network, a wired network or any combination of wireless network and wired network, and may be configured to connect one or more transmitting devices 704 and one or more receiving devices 708 to server 702. For example, network 706 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 706 may include, without limitation, telephone lines, fiber optics, IEEE Ethernet 802.3, a wide area network, a wireless personal area network, a LAN, or a global network such as the Internet. In addition, network 706 may support an Internet network, a wireless communication network, a cellular network, or the like, or any combination thereof. Network 706 may further include one network, or any number of the exemplary types of networks mentioned above, operating as a stand-alone network or in cooperation with each other. Network 706 may utilize one or more protocols of one or more network elements to which they are communicatively coupled. Network 706 may translate to or from other protocols to one or more protocols of network devices. Although network 706 is depicted as a single network, it should be appreciated that according to one or more examples, network 706 may comprise a plurality of interconnected networks, such as, for example, the Internet, a service provider's network, a cable television network, corporate networks, such as credit card association networks, and home networks.

In some examples, one or more transmitting devices 704 and one or more receiving devices 708 may be configured to communicate and transmit and receive data between each other without passing through network 706. For example, communication between the one or more transmitting devices 704 and the one or more receiving devices 708 may occur via at least one of NFC, Bluetooth, RFID, Wi-Fi, and/or the like.

At block 710, when the transmitting device 704 is preparing to process the sensitive data with symmetric cryptographic operation, the sender may update a counter. In addition, the transmitting device 704 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 712, the transmitting device 704 may take the selected cryptographic algorithm, and using the master symmetric key, process the counter value. For example, the sender may select a symmetric encryption algorithm, and use a counter which updates with every conversation between the transmitting device 704 and the receiving device 708. The transmitting device 704 may then encrypt the counter value with the selected symmetric encryption algorithm using the master symmetric key, creating a diversified symmetric key.

In some examples, the counter value may not be encrypted. In these examples, the counter value may be transmitted between the transmitting device 704 and the receiving device 708 at block 712 without encryption.

At block 714, the diversified symmetric key may be used to process the sensitive data before transmitting the result to the receiving device 708. For example, the transmitting device 704 may encrypt the sensitive data using a symmetric encryption algorithm using the diversified symmetric key, with the output comprising the protected encrypted data. The transmitting device 704 may then transmit the protected encrypted data, along with the counter value, to the receiving device 708 for processing.

At block 716, the receiving device 708 may first take the counter value and then perform the same symmetric encryption using the counter value as input to the encryption, and the master symmetric key as the key for the encryption. The output of the encryption may be the same diversified symmetric key value that was created by the sender.

At block 718, the receiving device 708 may then take the protected encrypted data and using a symmetric decryption algorithm along with the diversified symmetric key, decrypt the protected encrypted data.

At block 720, as a result of the decrypting the protected encrypted data, the original sensitive data may be revealed.

The next time sensitive data needs to be sent from the sender to the recipient via respective transmitting device 704 and receiving device 708, a different counter value may be selected producing a different diversified symmetric key. By processing the counter value with the master symmetric key and same symmetric cryptographic algorithm, both the transmitting device 704 and receiving device 708 may independently produce the same diversified symmetric key. This diversified symmetric key, not the master symmetric key, is used to protect the sensitive data.

As explained above, both the transmitting device 704 and receiving device 708 each initially possess the shared master symmetric key. The shared master symmetric key is not used to encrypt the original sensitive data. Because the diversified symmetric key is independently created by both the transmitting device 704 and receiving device 708, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 704 and the receiving device 708 may be governed by symmetric requirements for how often to create a new diversification value, and therefore a new diversified symmetric key. In an embodiment, a new diversification value and therefore a new diversified symmetric key may be created for every exchange between the transmitting device 704 and receiving device 708.

In some examples, the key diversification value may comprise the counter value. Other non-limiting examples of the key diversification value include: a random nonce generated each time a new diversified key is needed, the random nonce sent from the transmitting device 704 to the receiving device 708; the full value of a counter value sent from the transmitting device 704 and the receiving device 708; a portion of a counter value sent from the transmitting device 704 and the receiving device 708; a counter independently maintained by the transmitting device 704 and the receiving device 708 but not sent between the two devices; a one-time-passcode exchanged between the transmitting device 704 and the receiving device 708; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 704 and the receiving device 708. In effect, this may create a one-time use key, such as a single-use session key.

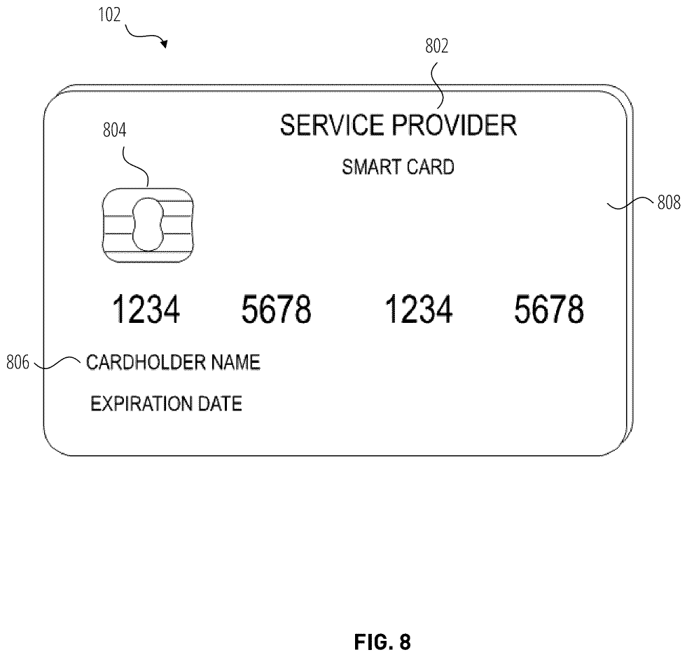

FIG. 8 illustrates an example configuration of a contactless card 102, which may include a contactless card, a payment card, such as a credit card, debit card, or gift card, issued by a service provider as displayed as service provider indicia 802 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 808, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

The contactless card 102 may also include identification information 806 displayed on the front and/or back of the card, and a contact pad 804. The contact pad 804 may include one or more pads and be configured to establish contact with another computing device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 9. These components may be located behind the contact pad 804 or elsewhere on the substrate 808, e.g. within a different layer of the substrate 808, and may electrically and physically coupled with the contact pad 804. The contactless card 102 may also include a magnetic strip or tape, which may be located on the back of the card (not shown in FIG. 8). The contactless card 102 may also include a Near-Field Communication (NFC) device coupled with an antenna capable of communicating via the NFC protocol. Embodiments are not limited in this manner.

As illustrated in FIG. 2, the contact pad 804 of contactless card 102 may include processing circuitry 916 for storing, processing, and communicating information, including a processor 902, a memory 904, and one or more interface(s) 906. It is understood that the processing circuitry 916 may contain additional components, including processors, memories, error and parity/CRC checkers, data encoders, anticollision algorithms, controllers, command decoders, security primitives and tamperproofing hardware, as necessary to perform the functions described herein.

The memory 904 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 904 may be encrypted memory utilizing an encryption algorithm executed by the processor 902 to encrypted data.

The memory 904 may be configured to store one or more applet(s) 908, one or more counter(s) 910, a customer identifier 914, and the account number(s) 912, which may be virtual account numbers. The one or more applet(s) 908 may comprise one or more software applications configured to execute on one or more contactless cards, such as a Java® Card applet. However, it is understood that applet(s) 908 are not limited to Java Card applets, and instead may be any software application operable on contactless cards or other devices having limited memory. The one or more counter(s) 910 may comprise a numeric counter sufficient to store an integer. The customer identifier 914 may comprise a unique alphanumeric identifier assigned to a user of the contactless card 102, and the identifier may distinguish the user of the contactless card from other contactless card users. In some examples, the customer identifier 914 may identify both a customer and an account assigned to that customer and may further identify the contactless card 102 associated with the customer's account. As stated, the account number(s) 912 may include thousands of one-time use virtual account numbers associated with the contactless card 102. An applet(s) 908 of the contactless card 102 may be configured to manage the account number(s) 912 (e.g., to select an account number(s) 912, mark the selected account number(s) 912 as used, and transmit the account number(s) 912 to a mobile device for autofilling by an autofilling service.

The processor 902 and memory elements of the foregoing exemplary embodiments are described with reference to the contact pad 804, but the present disclosure is not limited thereto. It is understood that these elements may be implemented outside of the contact pad 804 or entirely separate from it, or as further elements in addition to processor 902 and memory 904 elements located within the contact pad 804.

In some examples, the contactless card 102 may comprise one or more antenna(s) 918. The one or more antenna(s) 918 may be placed within the contactless card 102 and around the processing circuitry 916 of the contact pad 804. For example, the one or more antenna(s) 918 may be integral with the processing circuitry 916 and the one or more antenna(s) 918 may be used with an external booster coil. As another example, the one or more antenna(s) 918 may be external to the contact pad 804 and the processing circuitry 916.

In an embodiment, the coil of contactless card 102 may act as the secondary of an air core transformer. The terminal may communicate with the contactless card 102 by cutting power or amplitude modulation. The contactless card 101 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 918, processor 902, and/or the memory 904, the contactless card 101 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 908 may be added to contactless cards to provide a one-time password (OTP) for multifactor authentication (MFA) in various mobile application-based use cases. Applet(s) 908 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 908 may be configured to encode the OTP as an NDEF type 4 well known type text tag. In some examples, NDEF messages may comprise one or more records. The applet(s) 908 may be configured to add one or more static tag records in addition to the OTP record.

In some examples, the one or more applet(s) 908 may be configured to emulate an RFID tag. The RFID tag may include one or more polymorphic tags. In some examples, each time the tag is read, different cryptographic data is presented that may indicate the authenticity of the contactless card. Based on the one or more applet(s) 908, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 910 may be configured to increment. In some examples, each time data from the contactless card 102 is read (e.g., by a mobile device), the counter(s) 910 is transmitted to the server for validation and determines whether the counter(s) 910 are equal (as part of the validation) to a counter of the server.

The one or more counter(s) 910 may be configured to prevent a replay attack. For example, if a cryptogram has been obtained and replayed, that cryptogram is immediately rejected if the counter(s) 910 has been read or used or otherwise passed over. If the counter(s) 910 has not been used, it may be replayed. In some examples, the counter that is incremented on the card is different from the counter that is incremented for transactions. The contactless card 101 is unable to determine the application transaction counter(s) 910 since there is no communication between applet(s) 908 on the contactless card 102.

In some examples, the counter(s) 910 may get out of sync. In some examples, to account for accidental reads that initiate transactions, such as reading at an angle, the counter(s) 910 may increment but the application does not process the counter(s) 910. In some examples, when the mobile device 10 is woken up, NFC may be enabled and the device 110 may be configured to read available tags, but no action is taken responsive to the reads.

To keep the counter(s) 910 in sync, an application, such as a background application, may be executed that would be configured to detect when the mobile device 110 wakes up and synchronize with the server of a banking system indicating that a read that occurred due to detection to then move the counter 104 forward. In other examples, Hashed One Time Password may be utilized such that a window of mis-synchronization may be accepted. For example, if within a threshold of 10, the counter(s) 910 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 910 increases in the appropriate sequence, then it possible to know that the user has done so.

The key diversification technique described herein with reference to the counter(s) 910, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

FIG. 10 is a timing diagram illustrating an example sequence for providing authenticated access according to one or more embodiments of the present disclosure. Sequence flow 1000 may include contactless card 102 and computing device 104, which may include an application 1002 and processor 1004.

At line 1008, the application 1002 communicates with the contactless card 102 (e.g., after being brought near the contactless card 102). Communication between the application 1002 and the contactless card 102 may involve the contactless card 102 being sufficiently close to a card reader (not shown) of the computing device 104 to enable NFC data transfer between the application 1002 and the contactless card 102.

At line 1006, after communication has been established between computing device 104 and contactless card 102, contactless card 102 generates a message authentication code (MAC) cryptogram. In some examples, this may occur when the contactless card 102 is read by the application 1002. In particular, this may occur upon a read, such as an NFC read, of a near field data exchange (NDEF) tag, which may be created in accordance with the NFC Data Exchange Format. For example, a reader application, such as application 1002, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 1002 may be configured to transmit a request to contactless card 102, the request comprising an instruction to generate a MAC cryptogram.

At line 1010, the contactless card 102 sends the MAC cryptogram to the application 1002. In some examples, the transmission of the MAC cryptogram occurs via NFC, however, the present disclosure is not limited thereto. In other examples, this communication may occur via Bluetooth, Wi-Fi, or other means of wireless data communication. At line 1012, the application 1002 communicates the MAC cryptogram to the processor 1004.

At line 1014, the processor 1004 verifies the MAC cryptogram pursuant to an instruction from the application 122. For example, the MAC cryptogram may be verified, as explained below. In some examples, verifying the MAC cryptogram may be performed by a device other than computing device 104, such as a server of a banking system in data communication with the computing device 104. For example, processor 1004 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

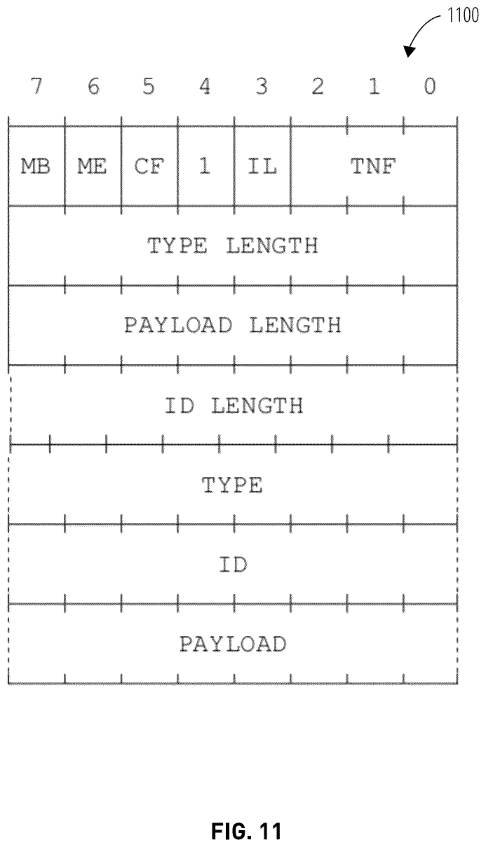

FIG. 11 illustrates an NDEF short-record layout (SR=1) data structure 1100 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

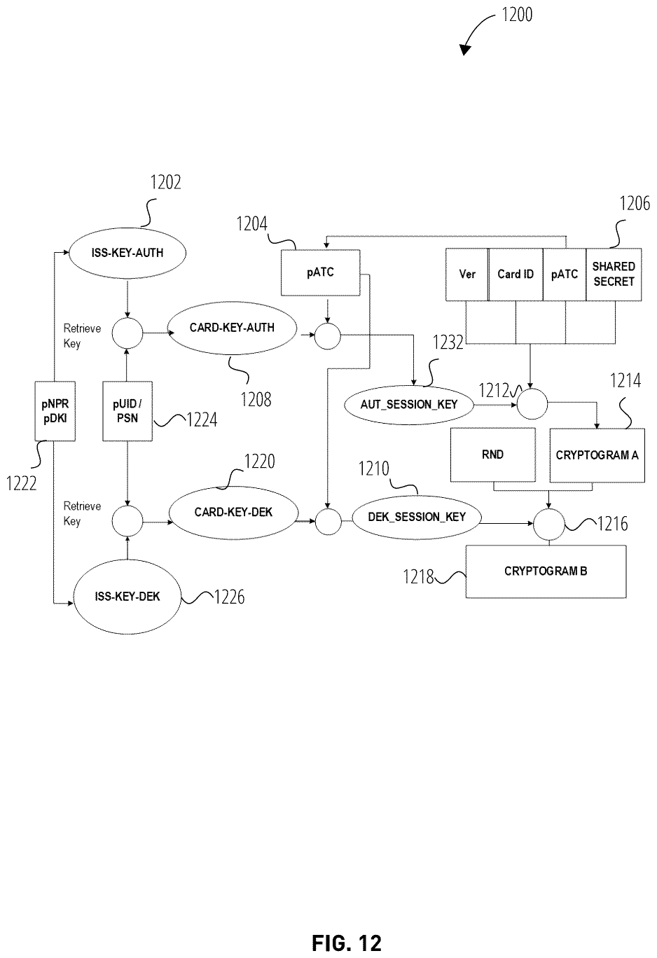

FIG. 12 illustrates a diagram of a system 1200 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 1202, 1226 may be required for each part of the portfolio on which the one or more applets is issued. For example, the first master key 1202 may comprise an Issuer Cryptogram Generation/Authentication Key (Iss-Key-Auth) and the second master key 1226 may comprise an Issuer Data Encryption Key (Iss-Key-DEK). As further explained herein, two issuer master keys 1202, 1226 are diversified into card master keys 1208, 1220, which are unique for each card. In some examples, a network profile record ID (pNPR) 522 and derivation key index (pDKI) 1224, as back office data, may be used to identify which Issuer Master Keys 1202, 1226 to use in the cryptographic processes for authentication. The system performing the authentication may be configured to retrieve values of pNPR 1222 and pDKI 1224 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1208 and Card-Key-Dek 1220). The session keys (Aut-Session-Key 1232 and DEK-Session-Key 1210) may be generated by the one or more applets and derived by using the application transaction counter (pATC) 1204 with one or more algorithms. To fit data into the one or more algorithms, only the 2 low order bytes of the 4-byte pATC 1204 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK) [F1])∥ALG (MK) [F2]}, where ALG may include 3DES ECB and MK may include the card unique derived master key.

As described herein, one or more MAC session keys may be derived using the lower two bytes of pATC 1204 counter. At each tap of the contactless card, pATC 1204 is configured to be updated, and the card master keys Card-Key-AUTH 508 and Card-Key-DEK 1220 are further diversified into the session keys Aut-Session-Key 1232 and DEK-Session-KEY 1210. pATC 1204 may be initialized to zero at personalization or applet initialization time. In some examples, the pATC counter 1204 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1232. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1232, as explained above. As explained above, the low order two bytes of the counter may be used to diversify for the one or more MAC session keys. As explained below, AUT-Session-Key 1232 may be used to MAC data 1206, and the resulting data or cryptogram A 1214 and random number RND may be encrypted using DEK-Session-Key 1210 to create cryptogram B or output 1218 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1210 derived from the Card-Key-DEK 1220. In this case, the ATC value for the session key derivation is the least significant byte of the counter pATC 1204.

The format below represents a binary version example embodiment. Further, in some examples, the first byte may be set to ASCII ‘A’.

| Message Format | | | | | | |
|---|---|---|---|---|---|---|
| 1 | 2 | 4 | | 8 | | 8 |
| 0x43 (Message | Version | pATC | | RND | | Cryptogram A |
| Type ‘A’) | | | | | | (MAC) |
| Cryptogram A | | | | | | |
| (MAC) | 8 bytes | | | | | |
| MAC of | | | | | | |
| 2 | 8 | 4 | 4 | | 18 bytes input data | |
| Version | pUID | pATC | Shared Secret | | | |

| Message Format | | | | |
|---|---|---|---|---|
| 1 | 2 | 4 | 16 | |
| 0x43 (Message | Version | pATC | Cryptogram B | |
| Type ‘A’) | | | | |
| Cryptogram A | | | | |
| (MAC) | 8 bytes | | | |
| MAC of | | | | |
| 2 | 8 | 4 | 4 | 18 bytes input data |
| Version | pUID | pATC | Shared Secret | |
| Cryptogram B | 16 | | | |
| Sym Encryption | | | | |
| of | | | | |
| 8 | 8 | | | |
| RND | Cryptogram | | | |
| | A | | | |

Another exemplary format is shown below. In this example, the tag may be encoded in hexadecimal format.

| Message | | | | | |
|---|---|---|---|---|---|
| Format | | | | | |
| 2 | 8 | 4 | | 8 | 8 |
| Version | pUID | pATC | | RND | Cryptogram |
| | | | | | A |
| | | | | | (MAC) |
| 8 bytes | | | | | |
| 8 | 8 | 4 | 4 | 18 bytes input data | |
| pUID | pUID | pATC | Shared Secret | | |

| Message | | | |
|---|---|---|---|
| Format | | | |
| 2 | 8 | 4 | 16 |
| Version | pUID | pATC | Cryptogram B |

| 8 bytes | | | | |
|---|---|---|---|---|
| 8 | | 4 | 4 | 18 bytes |
| pUID | pUID | pATC | Shared Secret | input data |
| Cryptogram B | 16 | | | |
| Sym | | | | |
| Encryption | | | | |
| of | | | | |
| 8 | 8 | | | |
| RND | Cryptogram | | | |
| | A | | | |

The UID field of the received message may be extracted to derive, from master keys Iss-Key-AUTH 502 and Iss-Key-DEK 1126, the card master keys (Card-Key-Auth 1108 and Card-Key-DEK 1120) for that particular card. Using the card master keys (Card-Key-Auth 508 and Card-Key-DEK 1220), the counter (pATC) field of the received message may be used to derive the session keys (Aut-Session-Key 1232 and DEK-Session-Key 1210) for that particular card. Cryptogram B 1218 may be decrypted using the DEK-Session-KEY, which yields cryptogram A 1214 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 1214, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1232. The input data 1206 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′00′ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1212, data 1206 is processed through the MAC using Aut-Session-Key 1232 to produce MAC output (cryptogram A) 1214, which is encrypted.

In order to provide additional protection against brute force attacks exposing the keys on the card, it is desirable that the MAC cryptogram 1214 be enciphered. In some examples, data or cryptogram A 1214 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1210. In the encryption operation 1216, data or cryptogram A 1214 and RND are processed using DEK-Session-Key 510 to produce encrypted data, cryptogram B 1218. The data 1214 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

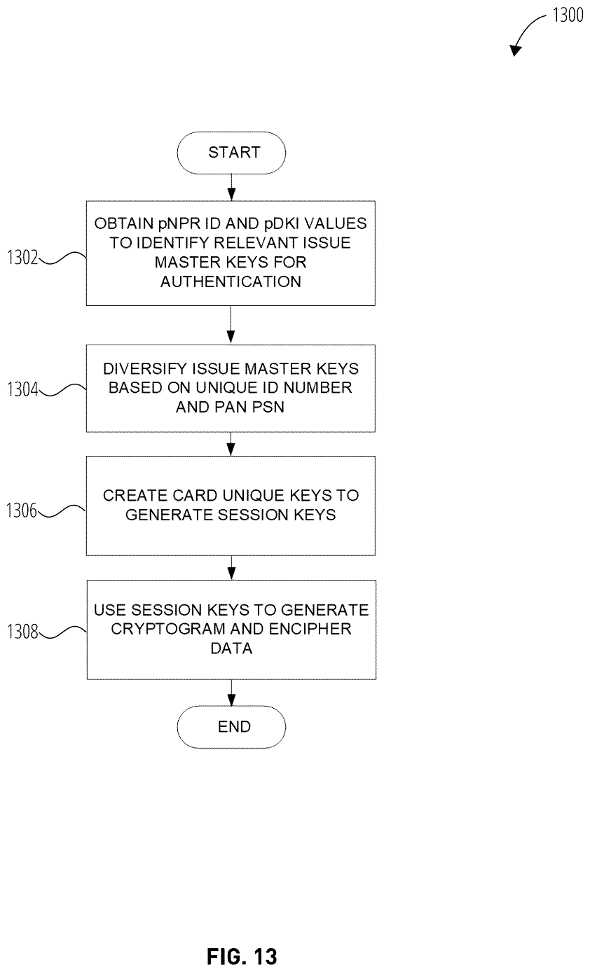

FIG. 13 illustrates a method 1300 for generating a cryptogram. For example, at block 1302, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 1304, Issuer Master Keys may be diversified by combining them with the card's unique ID number (pUID) and the PAN sequence number (PSN) of one or more applets, for example, a payment applet.

At block 1306, Card-Key-Auth and Card-Key-DEK (unique card keys) may be created by diversifying the Issuer Master Keys to generate session keys which may be used to generate a MAC cryptogram.

At block 1308, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

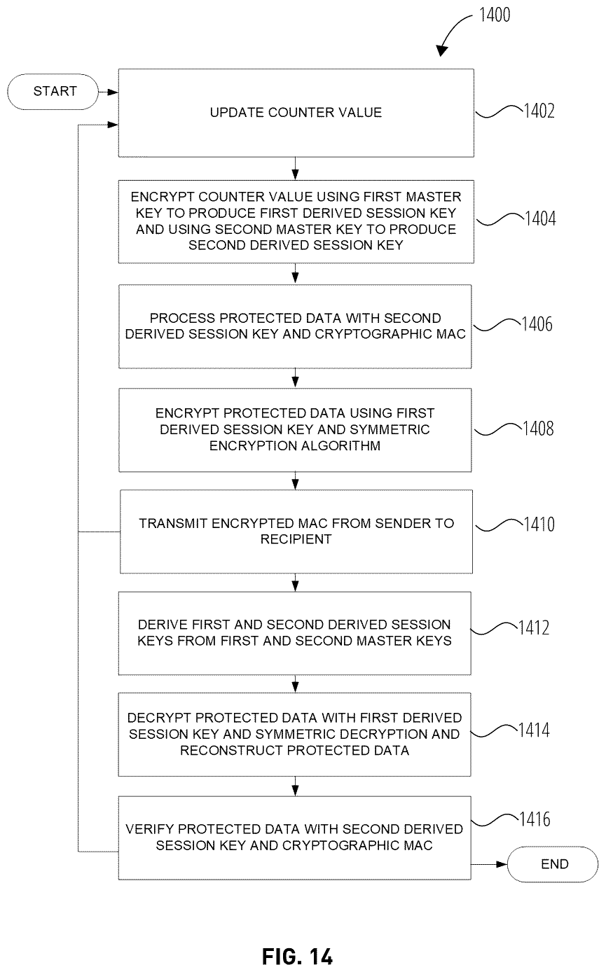

FIG. 14 depicts an exemplary process routine 1400 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 1402, and other data, such as data to be protected, which it may secure share with the recipient.

At block 1404, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 1406, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 1408, the data to be protected may be encrypted by the sender using the data encryption-derived session key in conjunction with a symmetric encryption algorithm. In some examples, the MAC is combined with an equal amount of random data, for example each 8 bytes long, and then encrypted using the second session key (DEK-Session-Key).

At block 1410, the encrypted MAC is transmitted, from the sender to the recipient, with sufficient information to identify additional secret information (such as shared secret, master keys, etc.), for verification of the cryptogram.

At block 1412, the recipient uses the received counter value to independently derive the two derived session keys from the two master keys as explained above.

At block 1414, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 1416, the data integrity-derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and the recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 1402), and a new set of session keys may be created (at block 1410). In some examples, the combined random data may be discarded.

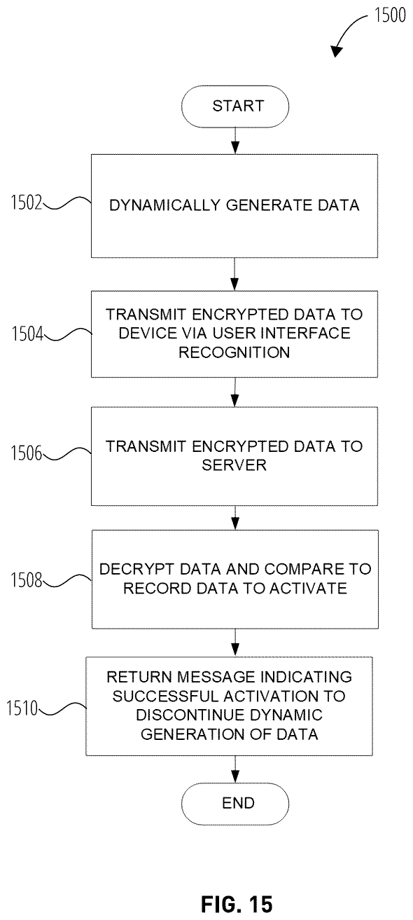

FIG. 15 illustrates a method 800 for card activation according to an example embodiment. For example, card activation may be completed by a system including a card, a device, and one or more servers. The contactless card, device, and one or more servers may reference same or similar components that were previously explained a, such as contactless card 102, computing device 104, and a server.

In block, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1504, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1506, the one or more portions of the data may be communicated to one or more servers, such as a card issuer server. For example, one or more encrypted portions of the data may be transmitted from the device to the card issuer server for activation of the card.

In block 1508, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1510, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

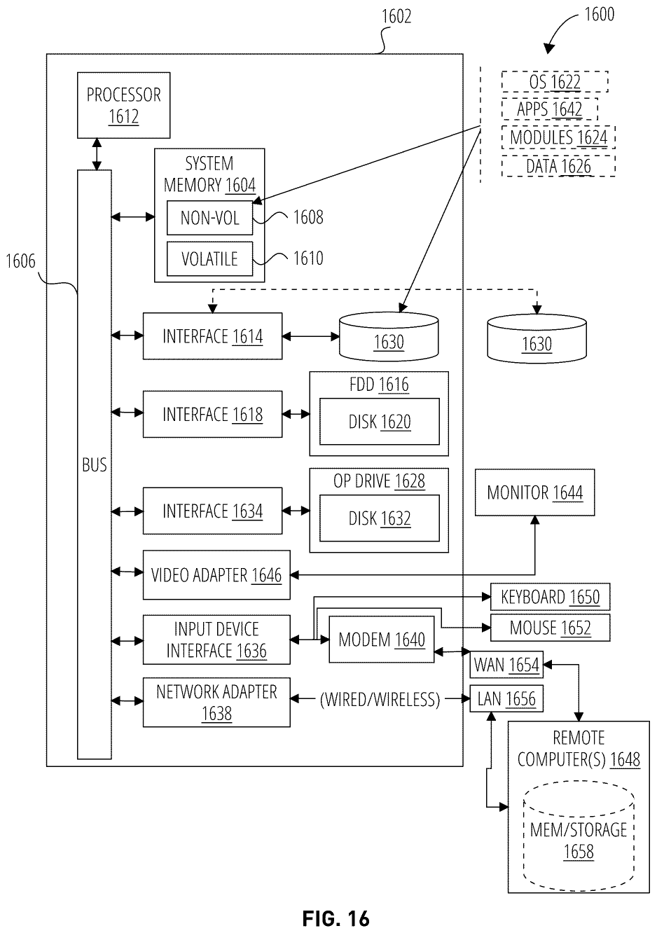

FIG. 16 illustrates an embodiment of an exemplary computer architecture 1600 suitable for implementing various embodiments as previously described. In one embodiment, the computer architecture 1600 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 16, the computing architecture 100 includes a processor 1612, a system memory 1604 and a system bus 1606. The processor 1612 can be any of various commercially available processors.

The system bus 1606 provides an interface for system components including, but not limited to, the system memory 1604 to the processor 1612. The system bus 1606 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1604 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 16, the system memory 1604 can include non-volatile 1608 and/or volatile 1610. A basic input/output system (BIOS) can be stored in the non-volatile 1608.

The computer 1602 may include various types of computer-readable storage media in the form of one or more lower speed memory units, including an internal (or external) hard disk drive 1630, a magnetic disk drive 1616 to read from or write to a removable magnetic disk 1620, and an optical disk drive 1628 to read from or write to a removable optical disk 1632 (e.g., a CD-ROM or DVD). The hard disk drive 1630, magnetic disk drive 1616 and optical disk drive 1628 can be connected to system bus 1606 the by an HDD interface 1614, and FDD interface 1618 and an optical disk drive interface 1634, respectively. The HDD interface 1614 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1608, and volatile 1610, including an operating system 1622, one or more applications 1642, other program modules 1624, and program data 1626. In one embodiment, the one or more applications 1642, other program modules 1624, and program data 1626 can include, for example, the various applications and/or components of the systems discussed herein.

A user can enter commands and information into the computer 1602 through one or more wire/wireless input devices, for example, a keyboard 1650 and a pointing device, such as a mouse 1652. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1612 through an input device interface 1636 that is coupled to the system bus 1606 but can be connected by other interfaces such as a parallel port, IEEE 1394 serial port, a game port, a USB port, an IR interface, and so forth.

A monitor 1644 or other type of display device is also connected to the system bus 1606 via an interface, such as a video adapter 1646. The monitor 1644 may be internal or external to the computer 1602. In addition to the monitor 1644, a computer typically includes other peripheral output devices, such as speakers, printers, and so forth.

The computer 1602 may operate in a networked environment using logical connections via wire and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all the elements described relative to the computer 1602, although, for purposes of brevity, only a memory and/or storage device 1658 is illustrated. The logical connections depicted include wire/wireless connectivity to a local area network 1656 and/or larger networks, for example, a wide area network 1654. Such LAN and WAN networking environments are commonplace in offices and companies, and facilitate enterprise-wide computer networks, such as intranets, all of which may connect to a global communications network, for example, the Internet.

When used in a local area network 1656 networking environment, the computer 1602 is connected to the local area network 1656 through a wire and/or wireless communication network interface or network adapter 1638. The network adapter 1638 can facilitate wire and/or wireless communications to the local area network 1656, which may also include a wireless access point disposed thereon for communicating with the wireless functionality of the network adapter 1638.

When used in a wide area network 1654 networking environment, the computer 1602 can include a modem 1640, or is connected to a communications server on the wide area network 1654 or has other means for establishing communications over the wide area network 1654, such as by way of the Internet. The modem 1640, which can be internal or external and a wire and/or wireless device, connects to the system bus 1606 via the input device interface 1636. In a networked environment, program modules depicted relative to the computer 1602, or portions thereof, can be stored in the remote memory and/or storage device 1658. It will be appreciated that the network connections shown are exemplary and other means of establishing a communications link between the computers can be used.

The computer 1602 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

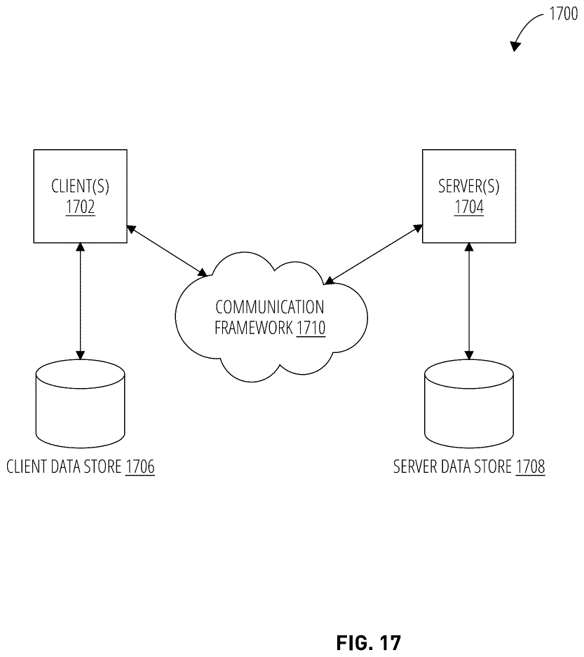

FIG. 17 is a block diagram depicting an exemplary communications architecture 1700 suitable for implementing various embodiments as previously described. The communications architecture 1700 includes various common communications elements, such as a transmitter, receiver, transceiver, radio, network interface, baseband processor, antenna, amplifiers, filters, power supplies, and so forth. The embodiments, however, are not limited to implementation by the communications architecture 1700, which may be consistent with systems and devices discussed herein.

As shown in FIG. 17, the communications architecture 1700 includes one or more client(s) 1702 and server(s) 1704. The server(s) 1704 may implement one or more functions and embodiments discussed herein. The client(s) 1702 and the server(s) 1704 are operatively connected to one or more respective client data store 1706 and server data store 1708 that can be employed to store information local to the respective client(s) 1702 and server(s) 1704, such as cookies and/or associated contextual information.

The client(s) 1702 and the server(s) 1704 may communicate information between each other using a communication framework 1710. The communication framework 1710 may implement any well-known communications techniques and protocols. The communication framework 1710 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1710 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1702 and the server(s) 1704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

What is claimed is:

1. A computing system, comprising:
memory configured to store instructions; and
one or more processors coupled with the memory, the one or more processors configured to execute the instructions, that when executed, cause the one or more processors to:
receive data from a property management platform, the data comprising a property identifier to identify a property and a customer identifier to identify a customer;
receive an indication from a computing device to configure a payment schedule for the property with an account associated with the customer;
receive, via the computing device, a cryptogram from a contactless card;
verify, with the cryptogram, that the contactless card is associated with the customer; and
establish the payment schedule for the property with the account based on verifying the contactless card is associated with the customer.

2. The computing system of claim 1, wherein the indication is received from a banking application configured to execute on the computing device, the banking application associated with the account.

3. The computing system of claim 1, wherein the data and the indication are received as part of an onboarding process to complete an electronic lease agreement for the property, wherein the electronic lease agreement is between the customer and an operator of the property management platform.

4. The computing system of claim 1, wherein the cryptogram comprises a counter value and a unique identifier.

5. The computing system of claim 4, wherein the one or more processors to compare at least one of the counter value and the unique identifier to stored values to verify the contactless card is associated with the customer.

6. The computing system of claim 5, comprising storage configured to store the stored values, and the one or more processors to verify the customer linked to the unique identifier in the storage to verify the contactless card is associated with the customer.

7. The computing system of claim 1, wherein the cryptogram is encrypted with diversified by the contactless card, and the one or more processors to decrypt the cryptogram with keys generated based on stored data in storage.

8. The computing system of claim 1, wherein the instructions are further configured to cause one or more processors to send a second indication to the property management platform to indicate the establishment of the payment schedule.

9. A computer-implemented method, comprising:
receiving, by a banking system, a request to establish a payment schedule for a property utilizing an account associated with a customer from a property management platform, the request comprising a property identifier to identify the property and a customer identifier to identify the customer;
sending, to a mobile device associated with the customer, a second request to perform a verification with a contactless card;
receiving, via the mobile device, a cryptogram from the contactless card;
verifying, by the banking system, the cryptogram; and
establishing the payment schedule for the property with the account based on the verifying of the cryptogram.

10. The computer-implemented method of claim 9, wherein the second request is sent to a mobile banking application executing on the mobile device, the second request to provide a prompt on a display of the mobile device to bring the contactless card within a range of the mobile device.

11. The computer-implemented method of claim 9, wherein receiving the request to establish a payment schedule is part of an onboarding process to complete an electronic lease agreement for the property, wherein the electronic lease agreement is between the customer and an operator of the property management platform.

12. The computer-implemented method of claim 9, wherein the cryptogram comprises a counter value and a unique identifier maintained by the contactless card.

13. The computer-implemented method of claim 12, wherein verifying the cryptogram comprises comparing at least one of the counter values and the unique identifier to stored values to verify the contactless card.

14. The computer-implemented method claim 13, comprising storing, in storage, the stored values, and the method comprising verifying the customer is linked to the unique identifier in the storage to verify the contactless card is associated with the customer.

15. The computer-implemented method of claim 9, wherein the cryptogram is encrypted with diversified by the contactless card, and the method comprises decrypting, by the banking system, the cryptogram with keys generated based on stored data in storage.

16. The computer-implemented method of claim 9, comprising sending a second indication to the property management platform to indicate the establishment of the payment schedule.

17. A mobile device, comprising:
a display device;
memory configured to store instructions for a banking application; and
a processor coupled with the memory and the display device, and configured to execute the instructions, the processor, when executing the instructions, to:
receive, from a banking system, a request to provide data stored on a contactless card as part of an onboarding process to establish a payment schedule to provide payment to a property management platform;
present, on the display device, a prompt comprising instructions to tap or bring the contactless card within a wireless communication range of the mobile device;
receive a cryptogram from the contactless card based on the contactless card coming within the wireless communication range; and
send the cryptogram to the banking system for verification to establish the payment schedule.

18. The mobile device of claim 17, wherein the cryptogram comprises a counter value and a unique identifier.

19. The mobile device of claim 17, wherein the cryptogram is encrypted by the contactless card utilizing diversified keys generated on the contactless card.

20. The mobile device of claim 17, wherein the banking application is associated with the banking system.
